(19) United States
(12) Patent Application Publication
(10) Pub. No.: US 2005/0210318 A1
(43) Pub. Date: Sep. 22, 2005

(54) System and method for drive recovery following a drive failure

(75) Inventors: Kevin T. Marks, Round Rock, TX (US); Ahmad A. J. Ali, Austin, TX (US); Robert Clausen, Austin, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 10/805,811

(22) Filed: Mar. 22, 2004

(51) Int. Cl. G06F 11/00

(52) U.S. Cl. 714/7

(57) ABSTRACT

A system and method for rebuilding a drive is disclosed in which the write cache of the drive is enabled and a separate record is kept of the commands transmitted to the drive. On a periodic basis, the drive flushes the data in its cache, and the history of commands is cleared. When the drive is successfully rebuilt, the cache of the drive is disabled.

### TECHNICAL FIELD

The present disclosure relates generally to the field of data storage systems, and, more particularly, to a system and method for rebuilding a drive with an enabled write cache.

### BACKGROUND

As the value and the use of information continue to increase, individuals and businesses seek additional ways to process and store information. One option available to users is information handling systems. An information handling system generally processes, compiles, stores and/or communicates information or data for business, personal or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems, e.g., computer, personal computer workstation, portable computer, computer server, print server, network router, network hub, network switch, storage area network disk array, redundant array of independent disks (“RAID”) system and telecommunications switch.

Information handling systems often include one or more drives grouped into a drive array. Many drives include an associated write cache that can be selectively enabled or disabled. With respect to drives that include an enabled write cache, there is sometimes a delay between the time that the drive notifies the drive controller that the write was successful and the time that the data is written to the storage media of the drive. A drive with an enabled write cache will often direct or store write data in the drive's write cache. Once the write data is successfully transferred to the cache, the drive will transmit a notification to the drive controller to indicate that the write command was successfully executed. This notification is transmitted from the drive to the drive controller even though the write command's data has not yet been written to the permanent, and non-volatile, media of the drive. The placement of the write command's data in the write cache allows the control circuitry of the write controller to optimize the order that information is written to media in the drive.

This methodology is problematic, however, in the case of a write command that has been successfully written to the drive's cache, but has not yet been successfully written to the non-volatile media of the drive. In this case, the drive has notified the drive controller that the write command was successful. If a drive fails (e.g. the drive loses power or resets or the write cache becomes corrupted) in this circumstance, the data stored in the write cache may be lost and never written to disk. The drive controller, however, is unaware of the loss of data because the drive's control circuitry has indicated that the write command was executed. The drive controller and the drive are not synchronized and the data in the write cache that had not been written to disk is lost. To prevent this failure event from occurring, the writes caches of drives in a RAID system are often disabled. When the write cache of a drive has been disabled, the drive cannot temporarily store the write data to a cache, thereby forcing the drive to write the data directly to the non-volatile storage media of the drive. In this scenario, the drive does not notify the drive controller of a successful write until the drive has written the write data to its non-volatile storage media. When the write cache of a drive is disabled, however, its performance may be adversely affected, as the control circuitry of the drive cannot optimize the transfer of data from the cache to the permanent media of the drive.

RAID storage arrays are characterized by the ability to restore or rebuild the information on a drive following a failure. For example, in a RAID 5 array, parity information is stored on the drives in the array. If one of the drives fails, it is rebuilt based on the parity information stored on the other drives in the array. As the capacity of the media in drives increases, the restoration of a drive takes longer due to the increased amount of information that must be restored. Rebuild times in hours or one or more days are not uncommon for drives with media capable of storing tens or hundreds of gigabytes of data. While a drive in the array is being rebuilt, many RAID arrays run in a degraded mode. In degraded mode, the performance of the array may suffer because of the resources dedicated to rebuilding the drive. In addition, if the cache of the drive being rebuilt is disabled during the rebuild period, the time required for rebuilding the drive may be longer as compared with the time required to rebuild a drive that has an enabled write cache. Additionally, in many RAID levels, if a second drive fails while the array is in degraded mode, the array will be lost.

### SUMMARY

In accordance with the present disclosure, a system and method for rebuilding of a drive in a drive array are disclosed. The write cache of the drive being rebuilt is enabled. During the rebuild process, commands directed to the drive are also recorded in a journal associated with the drive controller. A synchronize command is periodically sent to the drive. In response to the synchronize command, the drive writes all of the data in the write cache that has not been written to the non-volatile media, to the media. After synchronization, the journal is cleared, as the writes commands have been executed against the non-volatile memory of the drive arrays.

An advantage of the system and method disclosed herein is shorter rebuild times for failed drives. Enabling the write cache for the drive being restored allows the drive's control logic to optimize the order that commands are written to the media. Enabling the write cache for the drive being restored also allows multiple write commands to be sent to the disk before the data associated with the write commands is written to the media in the drive. Because the write cache is enabled, the drive can be rebuilt quicker than a drive whose write cache was disabled during the rebuild process. Another advantage of the system and method disclosed here in that the described technique includes a provision that anticipates the possibility that a drive being rebuild may suffer a system failure while the write cache is enabled and during the rebuild process. To compensate for this possibility, commands are written to a journal and periodically synchronized against the drive. The synchronization process involves forcing all data in the drive cache that is associated with write commands to be written to the storage media of the drive. Storing a subset of potentially unsynchronized commands in the journal of the drive controller avoids the possibility of having to restart the rebuild process from the beginning. Instead, the rebuild process may be restarted from those commands stored in the journal in the event of a failure during the rebuild process (e.g., a power loss). As a result, the rebuild process described herein includes a safety mechanism that protects against a subsequent failure while not adversely affecting the performance of the rebuild process. Other technical advantages will be apparent to those of ordinary skill in the art in view of the following specification, claims, and drawings.

### BRIEF DESCRIPTION OF THE DRAWINGS

A more complete understanding of the present disclosure and advantages thereof may be acquired by referring to the following description taken in conjunction with the accompanying drawings, in which like reference numbers indicate like features, and wherein:

FIG. 1 is a diagram of a redundant storage array;

FIG. 2 is a drive of a storage array and an associated drive controller; and

FIG. 3 is a flow diagram of a method for rebuilding a drive of a drive array.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a person computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

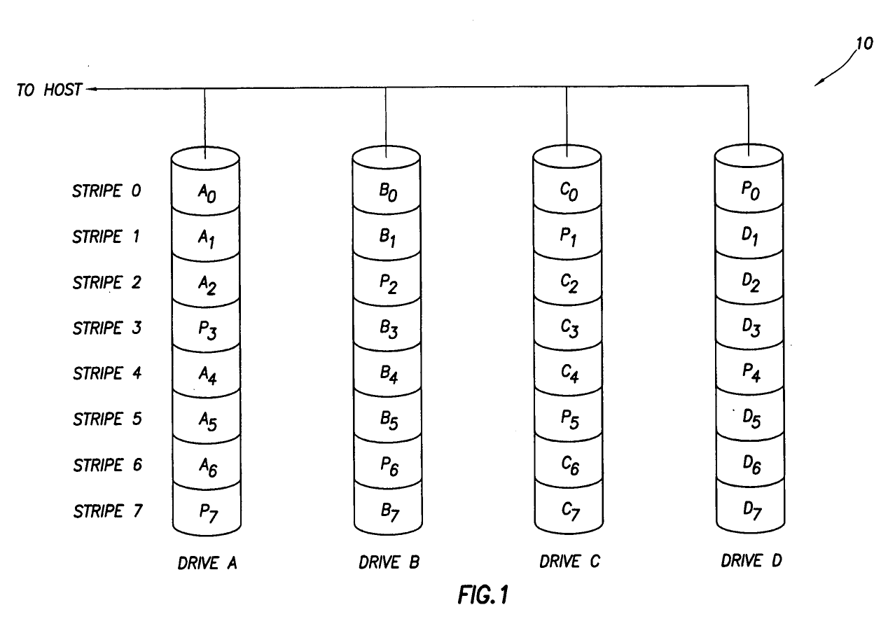

FIG. 1 is a diagram of a Level 5 RAID storage array, which is indicated generally at 10. Storage array 10 includes five drives, which are sometimes referred to as disks or volumes. Each of the four drives in the example of FIG. 1 includes eight stripes or rows of data, labeled Stripe 0 through Stripe 7. It should be recognized that the configuration of the RAID array of FIG. 1 is simply an illustration of a RAID array, and that RAID array may to be configured to have more or fewer drives with more or fewer stripes or rows. With reference to Stripe 0, data is stored Drive A, Drive B, and Drive C. The parity bits for Stripe 0, which are the result of an exclusive-OR operation performed on the content of Stripe 0 in Drive A, Drive B, and Drive C, are stored in Drive D and labeled P₀. As a second example of the data structure of the RAID Array 10, with reference to Stripe 7, data is stored in Drive B, Drive C, and Drive D. The parity bits for Stripe 7, which are the result of an exclusive-OR operation performed on the content of Stripe 7 in Drive B, Drive C, and Drive D, are stored in Drive A and labeled P₇. If, for example, Drive C were to fail or otherwise be identified as a degraded drive, the data in each stripe of Drive C would be rebuilt with the data in the other three drives of RAID array 10. As shown in FIG. 1, each of the drives in the storage array is coupled to a host. The RAID 5 array 10, is an example of a fault-tolerant RAID level wherein a single drive failure can be sustained and the failed drive can be rebuilt. Other fault tolerant RAID levels include 1, 4, 5, 6, 10, and 0+1.

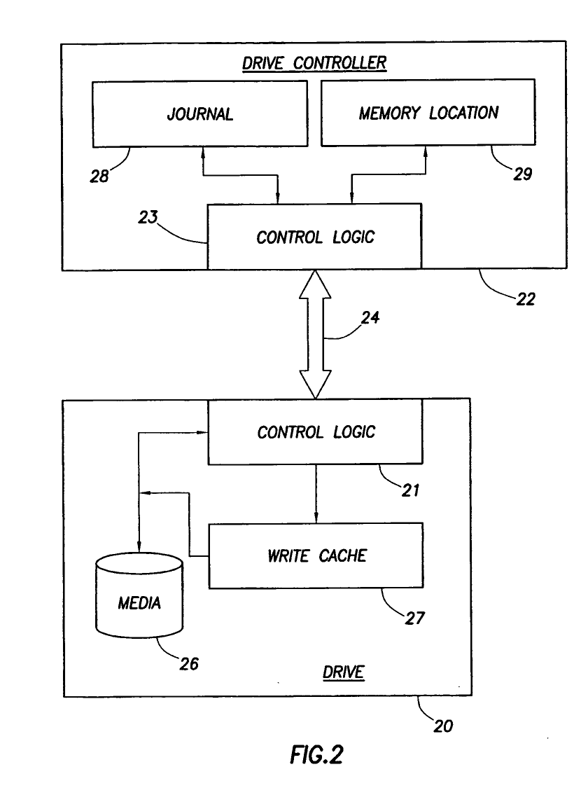

Each drive of a storage array communicates with and is controlled by a drive controller. FIG. 2 is a diagram of a drive 20 and a drive controller 22. Drive 20 and drive controller 22 are coupled to one another through a channel 24. Channel 24 may operate according to any number of communications protocols, including parallel or serial SCSI communications bus or link, a parallel or serial ATA communications bus or link, a Fibre Channel communications link, or a wireless communications link. Drive 20 includes a media storage element 26, control logic 21, and a write cache 27. Media storage 26 may be comprised of any media suitable for storing information, including magnetic media or optical media. Similarly, write cache 27 may be comprised any suitable storage mechanism for storing information. Write cache 27 is typically a volatile memory that is operable to provide faster access to its content as compared with storage media 26, which is typically non-volatile.

Control logic 21 of drive 20 responds to and processes commands from drive controller 22, including commands to read data from or write data to the drive 20, enable or disable write cache 27, and force all information in write cache 27 to be written to storage media 26. Control logic 21 also transmits data and notification information to drive controller 22. In addition, control logic 21 controls the storage media 26 and the write cache 27. Drive controller 22 includes a control logic element 23 that communicates with and directs a journal 28 and a memory location 29 of the drive controller. Examples of drive controller 22 according to the present disclosure include a RAID controller, a lower level ATA/SATA or SCSI controller, or both.

Journal 28 is an information storage location that stores a history of write commands directed to drive 20. The content of journal 28 can be controlled by control logic 23. Control logic 23 may issue a command to cause journal 28 to flush or empty its contents. Journal 28 is preferably non-volatile in nature so that the contents of journal 28 will be preserved if there is a sudden loss of power to the drive or the surrounding network. The content of journal 28 is a listing of the most recent commands sent to drive 20, together with a command count associated with each of the listed commands. Memory location 29 may be any memory location accessible by control logic 23. A running command count is stored in memory location 29. The value of the command count corresponds to the most recent write command sent to drive 20. The command count in memory location 29 may be manipulated by control logic 23. In particular, control logic 23 may store a new command count in memory location 29, retrieve the stored command count, or erase or reset the command count. Memory location 29 may comprise non-volatile memory so that the command count will be preserved if there is a loss of power to the drive or network.

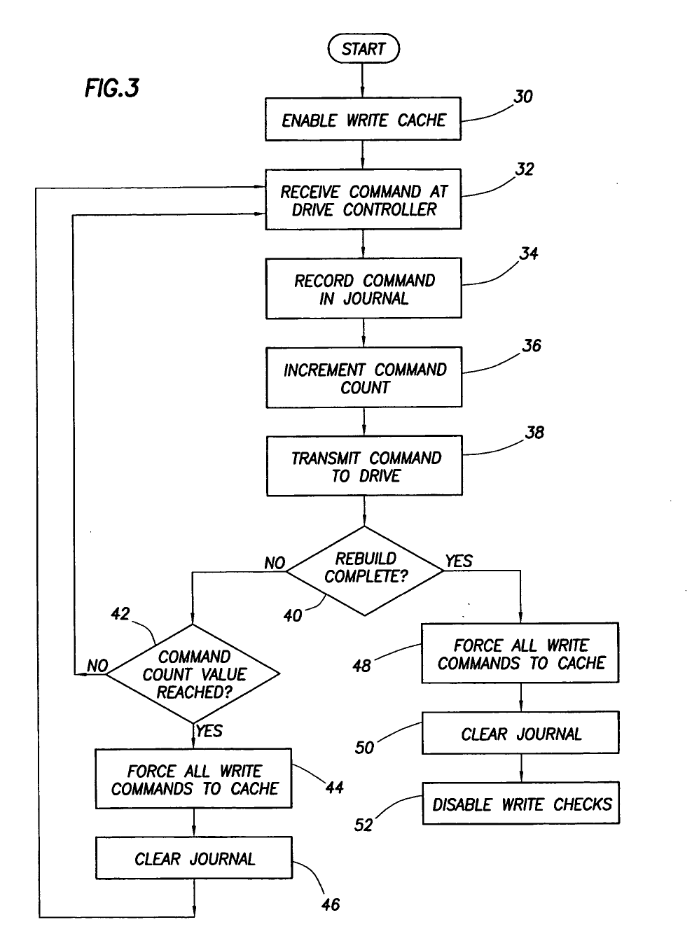

FIG. 3 is a flow diagram of a method for rebuilding a drive of a drive array. The steps of FIG. 3 are performed when a drive of the drive array must be rebuilt. A drive may need to be rebuilt for a number of reasons. The data on the drive may be corrupted or the drive may be one that has been added to the drive array. The drive may be rebuilt according to an automated rebuild that identifies conditions that mandate the rebuilding of the drive. As an alternative, a drive may be rebuilt following the manual direction of a system administrator. At step 30, the write cache of the drive is enabled, thereby allowing the drive to use its write cache to assist in optimizing the writes to the media of the drive. The write cache of drive 20 is typically enabled by a command sent from drive controller 22 to drive 20. As an example, if drive 20 is a SCSI drive, drive controller 22 transmits a MODE SELECT command to a Cache Mode Page in control logic 21 of drive 22 and sets the Write Cache Enable bit in the drive to 1. In an ATA or SATA environment, the drive controller sends a SET FEATURES command with a subcommand code to enable the write cache.

At step 32, the commands directed to the drive are received at a drive controller 22. These commands include the write commands necessary for the rebuild of the drive. As portions of the drive are rebuilt, the commands may include active loads commands to write new data to the rebuilt portions of the drive. At step 32, the received command is recorded in journal 28. As each command is received, a running list of the write commands is logged into journal 28. Following the recording of command in journal 28, the command count is incremented in the memory 29. At step 38, the received command is transmitted to the drive. As can be seen by the order of steps 32 through 38, the command is recorded at the journal before the command is transmitted to the drive. In this manner, a record is made of each command before the command is provided to the drive. When the command is received at the drive, the command, and its contents, may be stored in the cache or stored in the storage media of the drive. Because the write cache is enabled on the drive, the drive may choose a methodology for processing the command that makes most efficient use of the cache of the drive. Once the drive has successfully processed the command, whether through placement of the command in the cache or its storage media, the drive will issue a notification command to the controller to indicate that the command was successfully handled by the drive.

At step 40, following the transmittal by the drive of the notification to indicate a successful receipt of the command, it is determined whether the rebuild process is complete. If the drive rebuild process is not complete, it is determined at step 42 whether the command count has reached a predetermined maximum value. Once the command count reaches the predetermined maximum value, i.e., once a predetermined maximum number of commands are recorded in the journal, a series of steps are taken to synchronize the journal with the content of the storage media of the drive. The predetermined maximum value may be any suitable number that is not greater than the number of commands that may be stored in the journal. The predetermined maximum value should not be set so low that the journal and the storage media are synchronized so often that the synchronization steps interfere with the efficient completion of the rebuild process. The predetermined value should not be set so high that an excessive number of commands are stored in the journal. Having an excessive number of commands in the journal is contrary to the goal of tracking a limited number of commands for reexecution in the event of a subsequent loss of the drive being rebuilt. If the predetermined command count value has not been reached, the flow diagram continues at step 32 with the receipt of the next command at the drive controller.

If it is determined at step 42 that the predetermined command count value has been reached, the commands recorded in the journal are synchronized with the content of the storage media of the drive. The drive controller issues a command at step 44 to force all data stored in the cache that is associated with write commands to be written to the media. The command will be a command recognized by the control logic of the drive. In a SCSI environment, the drive controller issues a SYNCHRONIZE command. In an ATA or a SATA environment, the drive controller issues a FLUSH command. This command causes all the data associated with write commands in the cache to be flushed with respect to the storage media in the drive. Following this step, the cache of the drive does not include any write commands that have not been written to the storage media of the drive. At step 46, after step 44 has executed successfully, the journal is cleared and the command count is cleared to zero. The flow diagram continues at step 32 with the receipt at the drive controller of additional commands directed to the drive.

If it is determined at step 40 that the rebuild is complete, the flow diagram continues at step 48 with the issuance of a command to force all write commands from the cache so that these write commands can be executed with respect to the storage media of the drive. It will be recognized that step 48 is identical to step 44. At step 50, following the successful completion of step 48, the journal is cleaned and the command count is cleared to zero. It will be recognized that step 50 is identical to step 46. At step 52, the write cache of the drive is disabled. In a SCSI environment, the drive controller sends a MODE SELECT command to the Cache Mode Page in the control logic 21 of the drive 22 and sets the Write Cache Enable bit in the drive to 0. In an ATA or SATA environment, the drive controller sends a SET FEATURES command with a subcomm and code to disable the write cache. Disabling the write cache places the drive in a condition in which write commands directed to the storage drive cannot be cached in the drive, thereby insuring that all writes to the drive are written to the non-volatile storage media of the drive.

The system and method disclosed herein allows for the optimized write cache-enabled rebuild of a drive while protecting against a subsequent failure of the drive during the rebuild process. The recording of write command in the journal provides a resource for listing the most recently issued write commands. If the write cache of a drive loses power during a rebuild of the drive, the journal will include a listing of those command that may not have been written to non-volatile memory of the drive. As such, the contents of the journal can be used as a resource to avoid the necessity of restarting the rebuild process in the event of a failure of a loss of power to the cache of the drive being rebuilt.

It should be understood that the system and method disclosed herein is not limited to the precise architecture disclosed in the figures of the present disclosure. Rather, the system and method of the present disclosure could be employed with any suitable computer system architecture that involves the use of a redundant power supply. It should also be understood that the system and method disclosed herein is not limited in its application to a specific processor or processor family or to the application of a specific command to the processor. Rather, the system and method disclosed herein may be used with any processor able to modulate its power consumption through the modulation of one or more of its internal clocks. Although the present disclosure has been described in detail, it should be understood that various changes, substitutions, and alterations can be made hereto without departing from the spirit and the scope of the invention as defined by the appended claims.

1. A method for managing the rebuild commands directed to a drive, the drive having a non-volatile memory and a cache;
enabling the cache of the drive;
recording in a first memory location the rebuild commands directed to the drive; and
periodically causing the drive to flush the cached data associated with the rebuild commands to its non-volatile memory;
wherein the each command directed to drive is at least temporarily recorded in the memory location during the period that the cache of the drive is enabled.

2. The method for managing the rebuild commands directed to a drive of claim 1, further comprising the step of disabling the cache of the drive following the successful rebuild of the drive.

3. The method for managing the rebuild commands directed to a drive of claim 2, wherein the step of causing the drive to flush the cached data to its non-volatile memory comprises the steps of:
maintaining a count of the number of commands stored in the first memory location; and
causing the drive to flush the data to its non-volatile memory when the count of the number of commands stored in the first memory location reaches a predetermined threshold.

4. The method for managing the rebuild commands directed to a drive of claim 3, further comprising the step of clearing the first memory location and the count following the successful flushing of data from the cache to the non-volatile memory.

5. A storage array, comprising:
multiple drives, wherein each drive comprises,
non-volatile storage media for storing data; and
a write cache for caching data associated with write commands received by the drive; and
drive controllers, wherein each drive controller is associated with and coupled to a drive of the storage array, wherein each drive controller comprises a first memory, wherein the first memory is operable to store a history of write commands transmitted from each drive controller to its associated drive; and
wherein each drive controller is operable to manage the rebuild of its associated drive by:
enabling the write cache for the drive;
recording each write command sent to the drive in the first memory;
periodically causing the drive to flush the data in the write cache of the drive; and
disabling the write cache for the drive upon the successful completion of the rebuild of the drive.

6. The storage array of claim 5, wherein each drive controller is operable to clear its first memory following the indication of the successful flushing of the data in the write cache of the associated drive.

7. The storage array of claim 5, wherein each drive controller comprises a second memory for recording the number of commands stored in the first memory.

8. The storage array of claim 7, wherein each drive controller is operable to cause its associated drive to flush the data in the write cache when the number of commands stored in the first memory reaches a predetermined threshold.

9. The storage array of claim 5, wherein the first memory is non-volatile.

10. A method for rebuilding the storage media of a drive, wherein the drive is in communication with a write cache that may be selectively enabled, the method comprising:
enabling the write cache for the drive;
transmitting one or more commands to the drive;
writing the one or more commands to a journal; and
forcing the drive to flush the data in the write cache to the storage media.

11. The method for rebuilding the storage media of a drive of claim 10, further comprising the step of clearing the journal.

12. The method for rebuilding the storage media of a drive of claim 11, further comprising the step of disabling the write cache for the drive following the successful rebuild of the media of the drive.

13. The method for rebuilding media in a drive of claim 10, further comprising the steps of:
providing a count of commands sent to the drive; and
wherein the step of forcing the drive to flush the data in the write cache is performed once the count of commands sent to the drive reaches a predetermined value.

14. The method of claim 13, further comprising the step of clearing the journal following the successful flushing of the data in the write cache.

15. The method claim 13, further comprising the step of disabling the write cache following the successful rebuild of the media of the drive.

16. The method of claim 10, further comprising the step of clearing the journal after the drive flushes all data in the write cache and transmits a message indicating that the cached data was written to the media.

17. The method of claim 10, where the journal is comprised of non-volatile memory associated with a drive controller.

18. A drive controller operable to communicate with a drive through a communications channel, comprising:
a first memory for recording commands transmitted from the drive controller to the drive during the period that the drive is being rebuilt;
a second memory for storing a count of the commands recorded in the first memory;
wherein, during the period that the drive is being rebuilt, the drive controller is operable to enable the write cache of the drive and cause the drive to flush the data in the write cache of the drive when the count of the commands reaches a predetermined threshold.

19. The drive controller of claim 18, wherein the drive controller is operable to disable the write cache of the drive following the successful rebuild of the drive.

20. The drive controller of claim 19, wherein the first memory comprises non-volatile memory.
